(19) United States
(12) Patent Application Publication
(10) Pub. No.: US 2006/0120351 A1
(43) Pub. Date: Jun. 8, 2006

(54) Method and system for providing cellular voice, messaging and data services over IP networks to enterprise users

(76) Inventor: Bala Rajagopalan, Beaverton, OR (US)

Correspondence Address: BALA RAJAGOPALAN, 16364 SW CORNELIAN WAY, BEAVERTON, OR, 97007, US

(21) Appl. No.: 11/005,790

(22) Filed: Dec. 7, 2004

(51) Int. Cl. H04L 12/66; H04L 12/56

(52) U.S. Cl. 370/352; 370/401

(57) ABSTRACT

This invention describes a method and system for providing cellular voice, messaging and data services over IP networks to enterprise users. The key components of the system are programmable devices called cellular gateway and enterprise manager, management systems and various types of user equipment. Using these components, the present invention outlines methods for controlling and managing voice and messaging services provided to cellular subscribers over IP networks.

### CROSS REFERENCE TO RELATED APPLICATIONS

Provisional patent application No. 60/527,907 filed on Dec. 8, 2003.

### BACKGROUND OF INVENTION

This invention relates generally to providing cellular voice, messaging and data services over Internet Protocol (IP) networks.

The primary motivation for the present invention is the development of a system for providing an alternate means of delivering cellular services to enterprise users, specifically over private or public data networks such as the Internet. Presently, cellular networks suffer from two problems: the rapid increase in the number of users and the resulting lack of spectrum to cover concentrated user populations, and non-uniform quality of cellular coverage within service areas, leading to “holes” in coverage and unpredictable service. The second problem is especially acute inside buildings and other structures which tend to block radio waves. Conventional solutions to these problems involve creating smaller cells to accommodate more users, and providing “hotspot” coverage, i.e., targeted coverage within specific regions such as a building or a small locality. The present invention outlines another, cost-effective method for addressing this problem using IP networks for accessing cellular network services such as voice, data, or messaging, where “messaging” is the generic term used to indicate communication based on short messages, multimedia messages, instant messaging and “push-to-talk” voice communication.

As the popularity of cellular wireless services have increased, so has the penetration of broadband packet networks carrying IP traffic. This is particularly the case for enterprises, which have long used a variety of technologies to gain high-speed IP network access, in addition to maintaining their own private IP networks. The term “enterprise” in this disclosure is used to mean businesses, organizations and other entities that employ people and maintain strict administrative control of their resources. Enterprises provide fixed or wireless IP network connectivity to their approved users, using technologies such as Ethernet and wireless Local Area Network (LAN). Thus, the main motivation of the present invention is to enable enterprise users to access cellular services through the enterprise IP infrastructure. More precisely, the present invention enables:
a a voice call or a message destined to a cellular telephone to be delivered to a device attached to an enterprise IP network;
a a voice call or a message originating from a device attached to an enterprise IP network to be identified as a call or a message from a cellular user, and be delivered to a destination cellular device, landline telephone, or IP device (depending on the type of communication and the nature of the destination device);
a a device attached to an enterprise IP network to originate/terminate data traffic that would normally be originated/terminated by a cellular data terminal;
a the control and management of the above capabilities so that only authorized users are able to avail the services; and
a the maintenance of proper quality of service (QoS) for different types of communication.

The present invention results in the following advantages: first, from the point of view of an enterprise, its existing IP network facilities are used to deliver cellular services to its users in a controlled manner where these services were not available previously due to poor or non-existent radio coverage. Second, from the point of view of the cellular service provider, its subscribers receive better service quality in areas where they previously had poor or no service. Finally, from the point of view of users, they are able to utilize wireless communication in areas where they were not able to previously.

Another motivation for the present invention is to make possible direct communication between two enterprise users when they are both physically located within the enterprise premises. In this regard, the term “enterprise premises” refers to the same facility, or two geographically separated facilities controlled by the enterprise and connected by an IP network. The present invention allows the automatic detection of the presence of all users within the enterprise premises. Furthermore, it allows communication between two such users to be conducted using only the enterprise network resources and not involving the cellular service provider. This results in the following advantages: first, the existing network resources of an enterprise are used to carry local communication without the expense of involving the cellular service provider. Second, there is a potential for improving the responsiveness of communication when users within the enterprise are directly connected. Finally, the scalability of the overall system is improved as all communication is not handled by a centralized system located in the cellular service provider network. The present invention also allows a single identifier to be used to initiate communication with a user (e.g., his cellular telephone number) regardless of his location, whether within the enterprise premises or outside of it.

A further motivation for the present invention is to not rely exclusively on the use of wireless LAN technology and dual-mode handsets (i.e., handsets that communicate using both cellular and wireless LAN radios) for providing cellular services over IP networks. Rather, the usage of multiple types of devices, including dual-mode handsets, over both fixed and wireless packet network access are accommodated. This capability, however, introduces a problem with regard to authenticating users whose equipment is not controlled by the service provider. The present invention includes methods to eliminate this problem.

Yet another motivation for the present invention is to ensure that providing cellular services over IP networks does not require modifications to existing cellular or enterprise network equipment. To this end, the present invention introduces new entities that interface to existing enterprise and cellular networks transparently, i.e., without requiring any changes to the existing equipment.

The final motivation for the present invention is to provide unified messaging and notification services to cellular subscribers reachable over an enterprise IP network. These services allow a subscriber to customize the manner in which voice, data and messaging services are integrated. Using these services, for instance,
a A subscriber could receive textual notifications delivered to a data terminal (e.g., a personal computer) attached to the IP network when a call destined to his cellular telephone could not be completed;
a A voice message left for the cellular telephone number could be delivered by email;
a The user's telephone number can be used as a universal identifier to communicate with him through voice, text or multimedia messaging, with delivery to different devices being controlled by the user.

Currently, indoor cellular coverage is provided in existing commercial systems using several techniques. Under one method, coverage is improved by placing antennas indoors to propagate radio signals. This technique does not increase the capacity of the system in terms of the total number of users accommodated. Under another method, small radio transceivers are placed in several locations indoor. These transceivers create small cells (variously referred to as microcells or picocells) that both improve coverage and increase the capacity of the system. This method, however, requires an additional communication infrastructure to be established and maintained within enterprises. Furthermore, such an infrastructure has to be established separately for each cellular technology such as GSM, CDMA, and iDEN. In contrast, the present invention enables the existing IP network infrastructure to be used to deliver cellular services with improved coverage and capacity.

IP-based communication systems for mobile users located within enterprises are commercially available. For instance, there are systems that provide voice or messaging communications over wireless LAN between users located within the enterprise premises. The present invention, however, integrates local communication with external cellular communication and also provides the means to control and manage services.

Finally, in current cellular systems, the service provider strictly controls access to the network. One important aspect of this is user authentication. Typically, authentication information is programmed by the cellular service providers in the user's handset directly, or in the Subscriber Identity Module (SIM) contained in the handset. In both cases, the authentication information is difficult, if not impossible, to tamper with. Authentication is accomplished typically using a challenge-response protocol, whereby a challenge is sent by the cellular network to the handset at specific points in time (e.g., when service is requested). The handset generates the expected response based on the configured authentication information. While this type of authentication ensures that only users in good standing with valid equipment receive service, it requires a specialized mechanism in user's equipment (e.g., SIM and an associated reader). The present invention allows the elimination of such specialized equipment while maintaining the security of the system. This simplifies the usage of devices such as Personal Digital Assistants (PDAs), laptop and desktop computers with software phones for receiving cellular services over IP networks.

### SUMMARY OF INVENTION

The primary object of the invention is to provide method and system for delivering cellular voice, data and messaging services over IP networks to enterprise users. The key elements of the system of this invention are:
a Cellular Gateway (CGW), an entity which is operated by the cellular service provider and provides the interworking between cellular networks and IP networks;
a Enterprise Manager (EM), an entity which resides in the enterprise's IP network. The EM provides the interworking between the enterprise and cellular network services, and allows the control and management of cellular services delivered over the enterprise IP network;
a Management systems, which are used to provision and manage services through the CGW and the EM; and
a User equipment comprising of dual-mode handsets, wireless IP phones, PDAs and laptops with software phones, etc.

The CGW is a functional entity that may be realized in several ways. Specifically, it can be realized as a separate programmable, physical device operated by the cellular service provider. Or, CGW functions may be incorporated in an existing programmable device such as a software-based Mobile Switching Center (MSC). In any case, the CGW interacts with the EM and IP network elements on one side, and with the existing cellular network elements on the other side. From the cellular network point of view, the CGW looks like another network element that implements compatible communication protocols. Thus, the CGW is able to present users connected to the packet network via the EM as if these users are directly attached to the cellular network. Further details of the operation of the CGW are described later in the context of the preferred embodiment of the present invention.

Similar to the CGW, the EM may be realized in multiple ways. The EM is operated by the enterprise network administrator, and it allows the control and management of services offered to enterprise users. The EM thus interfaces to the enterprise users on one side and to the CGW on the other.

One possible realization of the primary object of this invention is as follows. First, the EM is provisioned with the identities, access control and cellular subscription information pertaining to all authorized enterprise users, and the address of the CGWs operated by different cellular service providers. Consider now a cellular subscriber whose (IP capable) voice terminal encodes identification, authentication and other information provisioned by his cellular service provider. When the subscriber's terminal is attached to the enterprise network, it communicates its identity to the EM to establish the presence of the subscriber at a specific IP network address. The EM, after determining that the subscriber is an authorized enterprise user, communicates with the CGW on one side and the subscriber on the other to successfully authenticate the subscriber. The CGW registers the location of the subscriber in the appropriate databases of the cellular network. The registered location information is such that signaling pertaining to any telephone call destined to the subscriber's number would be directed to the CGW. The CGW then establishes a voice call over the IP network to the EM, and ultimately to the subscriber's voice terminal. Similarly, a voice call originated by the subscriber's voice terminal can be connected by the EM to the CGW and then to any cellular or fixed telephone, or another voice terminal attached to the IP network. In the case where the voice call is destined to another enterprise user known to the EM to be present within the enterprise, the EM directly connects the two users over the enterprise network rather than directing the call to the CGW. Also, specialized features pertaining to voice calls (such as call forwarding, call waiting, conferencing, etc) are implemented by the EM in cooperation with the CGW and possibly utilizing other equipment resident in the cellular network.

In addition to voice calls, text, multimedia, push-to-talk and instant messages can be originated/terminated by the user's data terminal via the EM and the CGW. Also, other data and information services offered by the cellular network can be accessed similarly. These descriptions are somewhat oversimplified, but more precise details on the method and the system of the present invention are described later in the context of the preferred embodiment.

Another object of this invention is to ensure that no modifications are required to existing cellular and enterprise network equipment. This is accomplished by letting the CGW interface to other cellular network equipment using compatible communication protocols. The CGW thus looks like another cellular network element. Furthermore, the CGW hides the IP network characteristics from the cellular network, and in coordination with the EM, interworks different voice/data terminals to the cellular network transparently. Similarly, the EM communicates with enterprise network elements using compatible protocols, thus imposing no new requirements on them.

A further object of the present invention is to make use of different types of voice/data terminals, and fixed and wireless network access to provide cellular services. This is accomplished under the present invention mainly by separating the functional aspects of SIM from its physical realization. Specifically, the identification of cellular subscribers to the cellular network, and the authentication of these subscribers may use capabilities present either in the terminal or in the EM. This feature accommodates both subscriber equipment controlled by the service provider such as dual-mode phones, and also other devices such as wireless IP phones and PDAs with software phones that can be used without an embedded SIM. While dual-mode phones require wireless LAN access to enterprise IP networks, other devices may be able to connect using fixed access such as Ethernet.

Yet another object of the present invention is to provide unified messaging and notification services to the cellular subscriber reachable over an enterprise IP network. These services allow the subscriber to customize the manner in which voice, data and messaging services are integrated, as described earlier. Under the present invention, these capabilities are realized by suitably programming the CGW and the EM. In essence, the CGW controls the manner in which services are delivered to the user over the IP network. Furthermore, the CGW is aware of the subscriber's IP address and the voice/data terminal capabilities. It can thus support presence-based services, such as instant messaging, and unified messaging features. Similar services are supported by the EM within the scope of the enterprise.

Other objects and advantages of the present invention will become apparent from the following descriptions, taken in connection with the accompanying drawings, wherein, by way of illustration and example, embodiments of the present invention are disclosed. The deficiencies of the prior technology may be remedied by these embodiments of the present invention.

The invention is not intended to be limited to the embodiments described herein, but is instead intended to include any variations which fall within the scope of the design. The drawings constitute a part of this specification and include an exemplary embodiment of the invention, which may be embodied in various forms. It is to be understood that in some instances various aspects of the invention may be shown exaggerated or enlarged to facilitate an understanding of the invention.

### BRIEF DESCRIPTION OF DRAWINGS

FIG. 1 depicts the components of the system in one embodiment of this invention.

FIG. 2 depicts the components of the cellular network in this embodiment of the invention.

FIG. 3 depicts the components of one enterprise site in this embodiment of the invention.

FIG. 4 depicts the components of another enterprise site in this embodiment of the invention.

FIG. 5 depicts the registration procedure when the user equipment is provisioned by the cellular service provider.

FIG. 6 depicts the registration procedure when the user equipment is not provisioned by the cellular service provider.

### DETAILED DESCRIPTION

Detailed descriptions of the preferred embodiments are provided herein. It is to be understood, however, that the present invention may be embodied in various forms. Therefore, specific details disclosed herein are not to be interpreted as limiting, but rather as a representative basis for teaching one skilled in the art to employ the present invention in virtually any appropriately detailed system, structure or manner.

While the invention has been described in connection with the preferred embodiments, it is not intended to limit the scope of the invention to the particular form set forth, but on the contrary, it is intended to cover such alternatives, modifications, and equivalents as may be included within the spirit and scope of the invention.

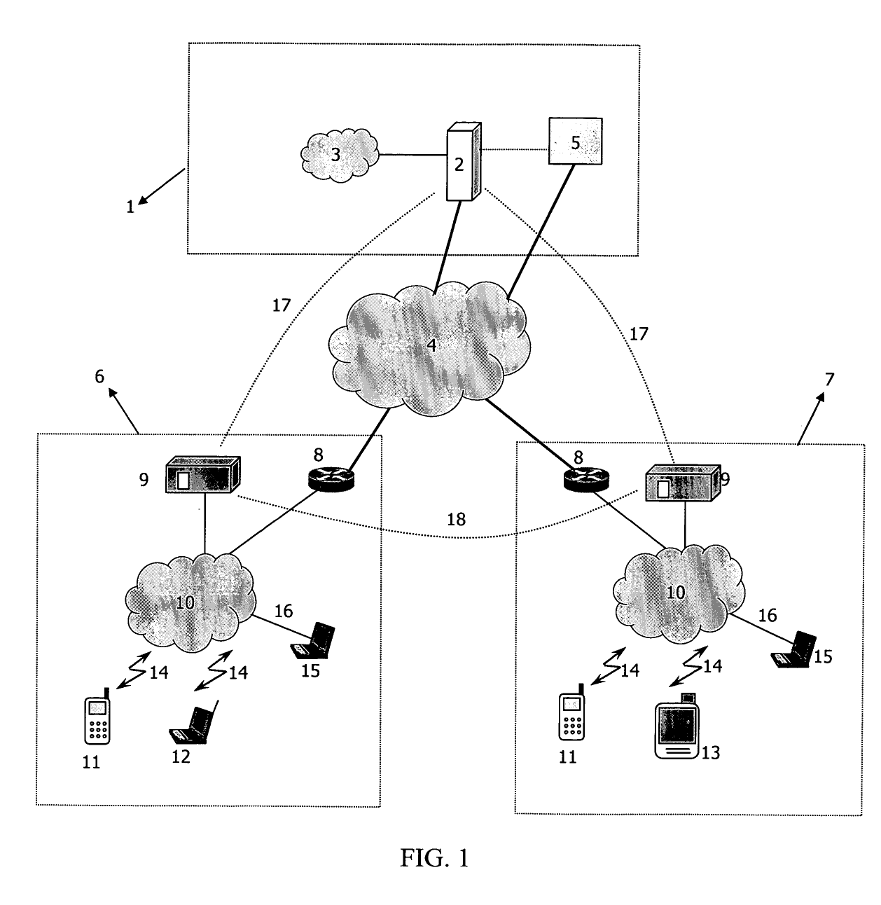

FIG. 1 depicts the components of the system in one embodiment of the invention. Here, the cellular service provider network (1) contains CGW (2), connected to existing cellular network equipment through signaling network (3). In this embodiment, CGW (2) is a separate, physical device. In other embodiments, the CGW functionality may be realized in an existing programmable device such as a software-based MSC. CGW (2) in this embodiment is connected to an IP network (4), which could be a private network or a public network maintained by an Internet Service Provider (ISP). CGW (2) is also connected to Voice over IP (VoIP) equipment (5), which includes media gateway functionality.

FIG. 1 also depicts two sites (6) and (7) of an enterprise network connected to IP network (4) by IP routers (8). These sites each contain an EM (9), which is connected to the internal IP network (10). User equipment such as dual-mode phones (11), laptops (12), and PDAs (13) connect to network (10) over wireless links (14), while other user equipment (15) connect to network (10) over fixed links (16). EM (9) interacts with CGW (2) using communication protocol (17). EMs also communicates with each other using protocol (18).

Although FIG. 1 depicts a single CGW (2) in the cellular network (1), it is possible in this embodiment of the invention to have multiple CGWs in network (1). Similarly, although FIG. 1 shows EM (9) communicating with a single CGW (2), it is possible in this embodiment of the invention for EM (9) to communicate with multiple CGWs in one or more cellular service provider networks. Also, while FIG. 1 depicts two sites, an enterprise could have more than two sites, each containing more than one EM. The methods of this invention are applicable in all these cases.

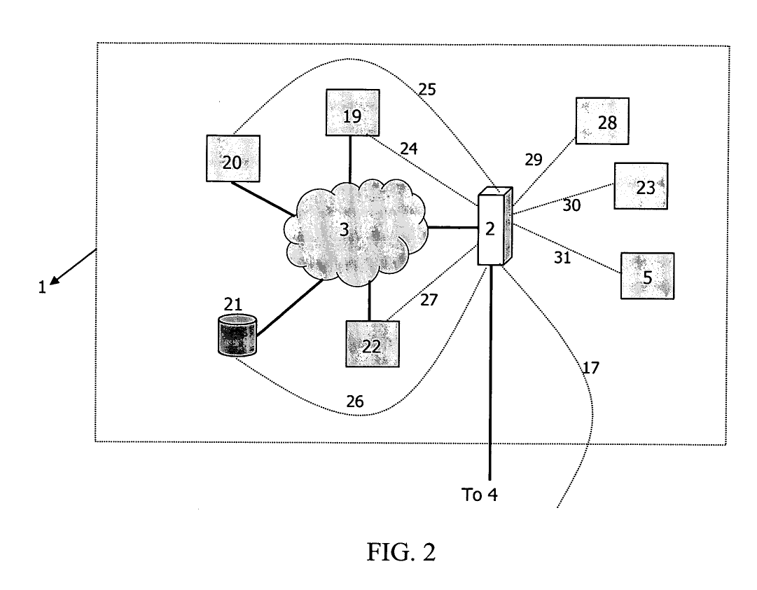

FIG. 2 depicts the key components of cellular network (1) in this embodiment of the invention. For concreteness, this depiction is based on the GSM cellular technology, although the structure will be similar under other cellular technologies. Thus, FIG. 2 depicts MSC (19), the Short Message Service Center (SMSC) (20), the Home Location Register (HLR)/Authentication Center (AuC) (21), and a signaling network (3) to which all these components are connected. In this embodiment, CGW (2) interacts with MSC (19), SMSC (20), and the HLR/AuC (21) using appropriate protocols (indicated by dotted lines (24-26), respectively) such that CGW (2) resembles another MSC to these entities. CGW (2) also maintains a local data base containing location information (i.e., IP address) pertaining to subscribers accessible over the IP network (similar to the Visitor Location Register, VLR). In the case of GSM, interactions (24) and (25) are based on the Mobile Application Part (MAP)-E, and interaction (26) is based on MAP-D. CGW (2) is also connected to a remote Multimedia Messaging Service (MMS) relay (22), and implements the MMS_{M} communication interface (27). Finally, CGW (2) connects to a remote management system (28) over interface (29), a push-to-talk server (23) over interface (30) and VoIP equipment (5) over interface (31).

Although FIG. 2 depicts a single MSC (19), CGW (2) may communicate with more than one MSC in network (1), in particular, the Gateway MSC (GMSC) connected to the telephone network. MSC (19) is thus a generic representation for all of them. Also, the functionality provided by (5) would depend on the functionality present in CGW (2). In the one extreme, CGW (2) may implement all functionality related to signaling and media interworking related to VoIP, obviating the need for (5). In the other extreme, CGW (2) may implement none of the VoIP functionality, relying entirely on (5) for all functions. In the current embodiment, CGW (2) implements signaling gateway and media gateway controller functionality, while (5) is assumed to implement media gateway functionality. This could be different in other embodiments of the present invention.

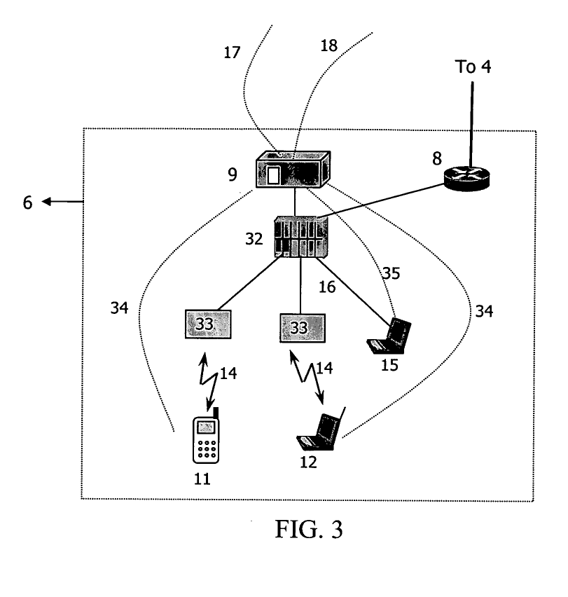

FIG. 3 depicts the details of the enterprise site (6) in this embodiment of the invention. Internal network (10) in FIG. 1 has been expanded to show a LAN switch (32) and wireless LAN Access Points (AP) (33). EM (9), IP router (8), APs (33) and fixed terminal (15) connect directly to LAN switch (32) thereby forming a local IP network. The EM (9) interacts with wireless user terminals (11) and (12) over interface (34). The EM (9) also interacts with the fixed user terminal (15) over interface (35).

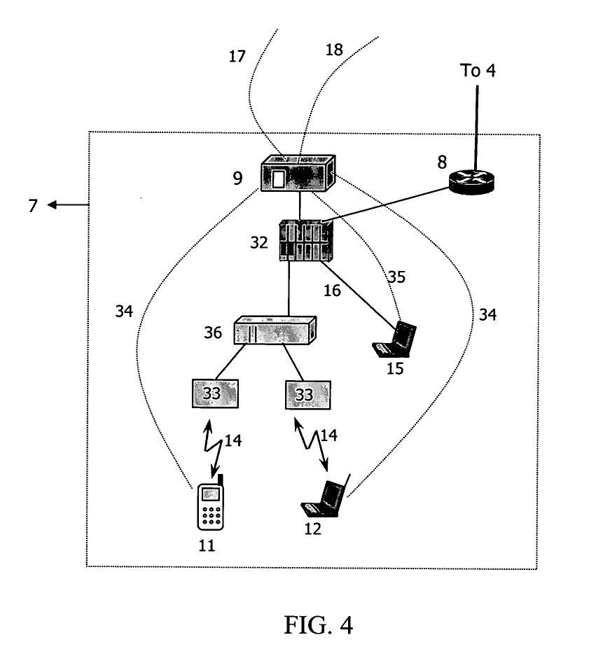

FIG. 4 depicts the details of enterprise site (7) in this embodiment of the invention. In addition to the components shown in FIG. 3, a wireless LAN switch or controller (36), which aids in the control and management of the wireless LAN (formed using APs (33)), is depicted in this figure. In this case, data to/from the APs (33) flow through the controller (36).

For the purposes of this description, FIG. 3 and FIG. 4 provide rather simplified depictions of internal enterprise network configurations. These network configurations in practice will be more complex. The methods of this invention, however, are generally applicable in all these configurations. Also, not shown in FIGS. 3 and 4 is a management system that allows the control and management of services provided by the EM (9).

Using the management system, EM (9) at an enterprise site is provisioned with a list of authorized users. The information provisioned may include the identity of the enterprise user, enterprise-specific authentication information (e.g., a password), his cellular subscriber identifier (e.g., International Mobile Subscriber Identity (IMSI) under GSM), identity of his cellular provider, his priority relative to other users, and any other information that is useful in controlling and managing usage. EM (9) may also be provisioned to allow guest access to an entire class of users without specifying individual user information. When there are multiple EMs in an enterprise (as depicted in FIG. 1), instead of provisioning the user information at each EM, the information may also be automatically downloaded from a server (e.g., the management system) by every EM. Furthermore, each EM may also automatically download the address of all other EMs in the enterprise.

Each EM (9) maintains a database of all users present in the enterprise. This database is built by running a registration procedure between the EM and the user equipment. The specifics of the registration procedure depends on the type and capabilities of the user equipment. For example, with dual-mode phones (12) and devices with SIM readers (e.g. laptop (13)), the following procedure is just one possibility that can be supported in the present embodiment of the invention. This procedure is described with reference to FIGS. 2, 3 and 4.

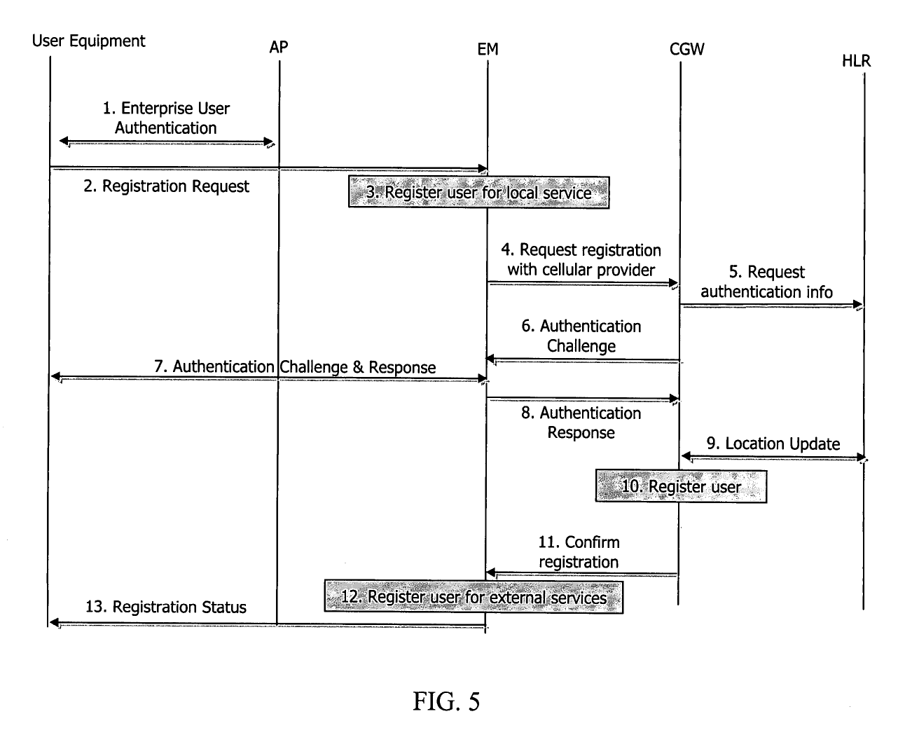

FIG. 5 depicts the sequence of messages between various entities involved in the procedure. These messages flow over wireless link (14) between user equipment (12) and AP (33), interface (34) between EM (9) and user equipment (12) via AP (33), interface (17) between EM (9) and CGW (2), and interface (25) between CGW (2) and HLR (21).

As depicted in FIG. 5, user equipment (12) firsts detects the wireless LAN coverage, completes the enterprise user authentication procedure, associates with AP (33), and obtains an IP address and the address of EM (9). It then registers with the EM by sending its cellular subscriber identity and the service provider identity (the subscriber identity may also implicitly include the service provider identity). EM (9) first verifies if the subscriber is an authorized enterprise user (this step may involve additional messages between EM (9) and user equipment (12) not shown). If so, EM (9) registers the user for local services, determines the address of CGW (2) in the cellular service provider's network and sends a “registration request” message with the subscriber identification, IP address and other relevant information. CGW (2) in turn contacts HLR (21) to obtain subscriber information, including authentication challenge and response. It then sends an authentication challenge to EM (9), which passes the challenge to user equipment (12). Using the embedded SIM or configured authentication key, user equipment (12) computes a response and sends it back to EM (9). EM (9) passes this response to CGW (2), which updates its local database with the IP address of the subscriber and that of the associated EM (9). CGW (2) also updates HLR (21) with location information that points to itself for receiving all incoming voice calls/messages destined to the subscriber. It then sends an “confirm” message to EM (9). The latter then registers the address of the user in its database and sends a “status” message to user equipment (12) indicating successful registration for local and external services.

The description above has been simplified to illustrate the general principles involved rather than specifying the actual protocols used or other capabilities possible under different embodiments of the present invention. Specifically, EM (9) acts as an intermediary between user equipment (12) and CGW (2), controlling usage of the enterprise network and interworking between procedures used by user equipment (12) and CGW (2). It is possible that different user equipment may not use the same procedure for authentication and registration (this feature is illustrated next). Also, the authentication procedure may result in the distribution or derivation of encryption keys for protecting the data transiting wireless interface (14). Finally, the procedure above may not complete under different error conditions, which have not been considered for reasons of simplicity.

Certain user equipment may not have an embedded SIM. To accommodate these types of equipment, the present invention incorporates a “proxy” authentication capability. Briefly, with this capability, the CGW authenticates the EM, and relies on the EM to authenticate enterprise users. Thus, as long as the EM represents a valid access location, the cellular service provider relies on the enterprise to strictly control access to its own resources. For proxy authentication to work, the CGW must implement a strong authentication procedure with the EM. For example, the EM may itself have embedded authentication keys and algorithms configured by different cellular service providers (the EM may also incorporate its own SIM provisioned by a service provider). The EM, on its part, may use various existing enterprise-specific user authentication procedures, and may also rely on lower layer procedures to validate users (e.g., screening valid equipment identity based on Medium Access Control (MAC) layer address).

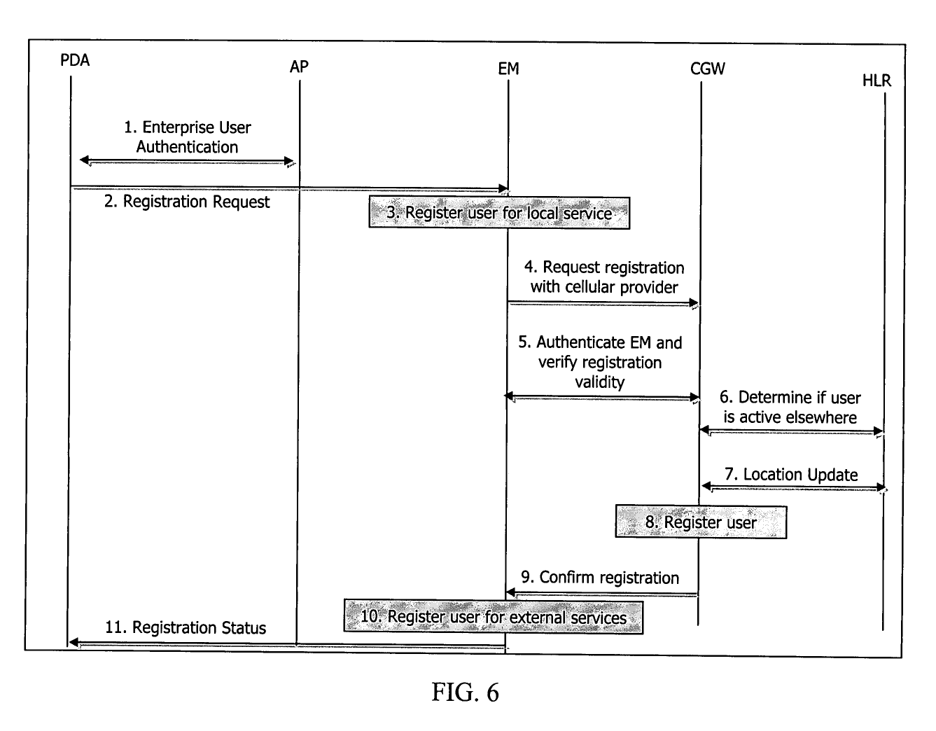

The resulting procedure is depicted in FIG. 6. This illustration is based on PDA (13) with a software phone accessing the enterprise network through wireless link (14) as shown in FIG. 4. It is assumed that PDA (13) incorporates a challenge-response procedure to log into the enterprise network (other procedures may also be used, depending on how enterprise clients are configured by the administrator). As before, PDA (13) completes the enterprise authentication procedure, associates with AP (33), and obtains an IP address and the address of the EM. It then registers with the EM as in the previous case, indicating an enterprise user identity and associated password or key. EM (9) verifies whether an authorized cellular subscriber has been identified, and if so, it determines the subscriber identity of the user and the address of the corresponding CGW (from the configured information). It sends a request to CGW (2), containing the subscriber's identifier, IP address and other relevant information, and its own identifier. The EM identifier in this case is specific to the particular service provider and it resembles any other subscriber identifier. CGW (2) uses the EM identifier to obtain authentication and other information from HLR (21). It then issues a challenge to EM (9), which computes a response using the SIM (or the configured key and procedures). Upon receiving the response, CGW (2) determines if the subscriber is already registered with the cellular network (e.g., using his cellular phone). If not, it updates its local database with the IP address of the subscriber and that of the associated EM (9). CGW (2) also updates HLR (21) with location information that points to itself for receiving all incoming voice calls/messages destined to the subscriber. It then sends a “confirm” message to EM (9), which registers the user's address in its database, and completes the registration procedure.

The procedure above allows a cellular subscriber to use any device with the appropriate capabilities to access cellular services without the need for service provider to provision the device. It requires that the subscriber deregister his regular cellular device from the network (e.g., turn the cellular phone off). This procedure still does not allow a non-subscriber to utilize the cellular network, since it works only for valid subscribers. The description above has been simplified to illustrate the general principles involved rather than the specific protocols that can be used or other capabilities possible under different embodiments of the present invention.

Once a subscriber is registered, incoming voice calls dialed to his cellular telephone number are routed as follows. With reference to FIGS. 2 and 3, signaling related to such calls are received by GMSC (19) or another MSC (19) in the cellular service provider network (1). GMSC or MSC (19) looks up HLR (21), which has the registration information pointing to CGW (2) as the visiting MSC (CGW (2) contains the VLR functionality, as described earlier). HLR (21) then provides CGW (2) with the identity of the subscriber and queries for a routing number. CGW (2) supplies an appropriate number that results in the signaling messages related to the call set up being routed to itself. CGW (2) determines the address of EM (9) corresponding to the subscriber from its local database. It then interacts with VoIP equipment (5) to determine if the data path can be established, and signals to EM (9) an incoming voice call destined to the subscriber identified along with other pertinent information. EM (9) in turn sends the appropriate signal to the user equipment (12) whose address it has in its local database. After receiving the appropriate response from the user equipment (12), EM (9) sends a response to CGW (2), which establishes the data path by suitably commanding the VoIP equipment (5) and completing the signaling on the cellular network side.

Voice calls dialed by the enterprise user to an external destination can be processed as follows. Considering FIGS. 2 and 3, user equipment (12) signals to EM (9) the destination number. Under the first option, EM (9) signals CGW (2) to establish the call. CGW (2) performs functions similar to the description above to complete the signaling and establish the data path. In another embodiment of the present invention, EM (9) may interface to local VoIP equipment, such as an IP Private Branch Exchange (PBX). In yet another embodiment of the present invention, EM (9) may itself incorporate IP PBX functions. In these cases, outgoing voice calls may be routed over the phone network or a VoIP network directly to the destination without involving CGW (2).

Incoming short messages, multimedia messages, and push-to-talk voice are delivered to the enterprise user using message flow sequence similar to that described for voice calls with the following exceptions. For short messages, CGW (2) interacts with SMSC (20) in addition to HLR (21). For multimedia messaging and push-to-talk voice, CGW (2) interacts with MMS relay (22) and push-to-talk server (23). Furthermore, the messaging data is carried directly between CGW (2), EM (9) and the user equipment, without involving VoIP equipment (5).

Short messages, multimedia messages, and push-to-talk voice spurts destined for external destinations from the enterprise user are signaled in the reverse sequence, i.e., from the user equipment to the EM, and from the EM to the CGW and then to SMSC, MMS relay or push-to-talk server. The associated data is carried directly between these entities.

A user is deregistered from the EM and the CGW under the following conditions. First, the user may explicitly or implicitly invoke signaling to deregister. Implicit deregistration occurs, for instance, when the user equipment is powered off. Considering FIG. 3, suppose dual-mode phone (13) is presently registered. Deregistering procedure involves signaling from (13) to EM (9). EM (9) then signals to CGW (2), which signals to HLR (21) to remove the user's location information. CGW (2) then removes the user's location information from its own database, and signals to EM (9), which does the same. The process completes when EM (9) signals success to the user equipment. Authentication of the user equipment (13) and EM (9) may be invoked during this procedure. Second, automatic deregistering occurs when the user equipment moves from the enterprise network and attaches to the cellular network. This is particularly relevant for dual-mode phones such as (13). In this case, HLR (21) is updated with new location information. It then commands CGW (2) to remove the location information pertaining to the subscriber. CGW (2) then commands EM (9) to remove the local information. Finally, deregistering also occurs when user equipment (13) cannot be reached during normal signaling communication. The procedure in this case is similar to the first case, except the user equipment is not involved. Once a subscriber is deregistered, the registration procedure must be executed again before the subscriber can receive services.

In this embodiment of the invention, EMs support direct communication between subscribers who are present in the enterprise premises. To this end, each EM obtains the addresses of other EMs in the enterprise, as described earlier. Each EM then communicates over interface (18) to exchange information about various users present (registered) in the enterprise. With this information, an EM is able to determine whether an outgoing voice call or message is destined to a subscriber internal or external to the enterprise. When the destination subscriber is present within the enterprise premises, signaling related to voice call or messaging is routed to the EM handling the destination directly, without involving the CGW. The data path is also established directly between the communicating devices. Because of this capability, the EM allows the following features: it permits enterprise users who are not cellular subscribers to correspond with those who are cellular subscribers (as long as both parties are present within the enterprise premises). It also allows an enterprise user who is a cellular subscriber to be reached using a single identifier (e.g., his cellular phone number) regardless of his location (internal or external to the enterprise) for both voice and messaging communication.

Similar to the EM, a CGW in this embodiment of the invention can support direct communication between subscribers known to be present under different EMs, as registered in its local data base. Specifically, when a voice call or messaging related signaling is received from an EM, the CGW can determine if the destination subscriber is reachable under another EM. In this case, the CGW need not involve any cellular network elements to complete the signaling and establish the data path directly between the source and destination user equipment.

By virtue of having knowledge about all voice calls in progress involving enterprise subscribers, EMs can support the provisioning of proper QoS in the enterprise network for voice traffic. Specifically, an application running in the management system can utilize the call-related information maintained by the EM to determine network resources used along various voice paths, monitor the QoS, and allow the network administrator to implement various policies regarding bandwidth allocation for voice. Such an application may interface to various network elements such as IP routers (8), LAN switches (32) and WLAN controllers (36) to configure these devices for provisioning and monitoring QoS as per the policies defined by the administrator.

Being fully involved in the signaling of voice and messaging services, EM (9) and CGW (2) in this embodiment of the invention can provide statistics on service usage for billing and other purposes.

As described earlier, the EM can provide varying levels of functionality related to voice calls. Specifically, EM can either directly provide advanced telephony features or interface with existing enterprise equipment for providing these features. The EM may also rely on the CGW and hence the cellular network to provide these features. Similarly, the EM can provide other functionality such as being a server for instant messaging, and implement various notification and unified messaging features. On the other hand, some of the EM functions may also be combined with other functions such as WLAN control. For instance, WLAN controller (36) can potentially provide certain functions described in this disclosure to cellular subscribers with wireless terminals, such as authentication. The present invention considers EM as a collection of functions that may be realized in various ways with the maximum degree of flexibility, and hence covers all such embodiments. A similar situation holds for CGW, as described earlier.

Finally, the EM and the CGW cooperate to enable the provisioning of directly billed data services to enterprise subscribers. Such services include downloading ring tones, games or other applications that are charged to the subscriber's account. Provisioning such services require that the subscriber to be identified reliably and data to be delivered only to the subscriber being billed. These services are typically available from servers in the cellular service provider's network. In this embodiment of the invention, traffic to servers in the service provider's network from the enterprise subscriber equipment is diverted to the EM, which then securely tunnels it to the CGW. Similarly, traffic from the servers is sent via the CGW and tunneled to the EM, and then to the user equipment. Several protocol options exist for such secure tunneling, and it is possible for the CGW to reliably identify the subscriber with any of these methods. The data services, however, are available only to user equipment provisioned by the service provider, such as dual-mode phones.

What is claimed is:

1. A system for enabling
a a voice call or a message destined to a cellular telephone to be delivered to a device attached to an enterprise Internet Protocol (IP) network;
a a voice call or a message originating from a device attached to an enterprise IP network to be identified as a call or a message from a cellular user, and be delivered to a destination cellular device, landline telephone, or IP device;
a a device attached to an enterprise IP network to originate/terminate data traffic that would normally be originated/terminated by a cellular data terminal; and
a the control and management of the above capabilities so that only authorized users are able to avail the services,
wherein the system comprises
a A programmable device called cellular gateway that is connected to the cellular network through standard signaling interfaces, resembles a cellular network element to other legacy cellular network devices, and maintains, among other information, a database of cellular subscriber identities and corresponding enterprise IP location information;
a A plurality of programmable devices called enterprise managers that are connected to the enterprise IP network, at least one at each site, and each of which maintain, among other information, a database of currently registered cellular subscriber identities and their corresponding enterprise IP addresses;
a A plurality of voice-over-IP media gateways connected to cellular network elements to convert circuit-switched voice to voice-over-IP, and vice versa;
a Management systems, which are used to provision and manage services through the cellular gateway and the enterprise manager;
a An IP communication link between the cellular gateway and each enterprise manager to transport signaling and data messages;
a An IP communication link between the cellular gateway and each voice-over-IP media gateway to transport signaling messages;
a An IP communication link between each enterprise manager and each voice-over-IP media gateway to transport data messages;
a IP communication links between the management systems, and the cellular gateway and enterprise managers they control; and
a Communication devices (user equipment) with software that allow them to communicate with each other and with the enterprise manager over the enterprise IP network.

2. The system of claim 1, wherein a communication device connected to an enterprise IP network is recognized in the cellular network by a method comprising
a Registering the cellular subscriber information and enterprise IP address associated with the device with an enterprise manager;
a The enterprise manager in turn registering the subscriber information along with an IP network address with the cellular gateway;
a The cellular gateway acting as an intermediary to translate cellular network authentication and location update functions into a form recognizable by the enterprise manager and the communication device, and similarly translating the responses back; and
a The cellular gateway registering the location of the subscriber in the appropriate databases of the cellular network such that signaling pertaining to voice and messaging that is destined to the subscriber would be directed to the gateway;

3. The system of claim 1, wherein a communication device without embedded cellular subscriber identification and authentication information, and connected to an enterprise IP network is recognized in the cellular network by a method comprising
a Provisioning the corresponding cellular subscriber identification information in an enterprise manager;
a Registering the enterprise user identity and IP address associated with the device with the said enterprise manager, after locally authenticating the user;
a The said enterprise manager in turn registering the provisioned cellular subscriber identification associated with the communication device and an IP address with the cellular gateway;
a The cellular gateway performing the location update function on behalf of the identified subscriber, after authenticating the enterprise manager and ensuring that subscriber is not already registered in the cellular network.

4. The system of claim 1, wherein a communication device with both cellular and wireless local area network radios automatically connects to an enterprise IP network by a method comprising
a Detecting the wireless link to the enterprise IP network by either automatic or user-initiated monitoring of wireless local area network messages;
a Completing the enterprise authentication procedures;
a Registering with an enterprise manager; and
a Completing the location update function.

5. The system of claim 1, wherein the plurality of enterprise managers collaborate to maintain the identity and IP address of all the cellular users connected to the enterprise IP network by a method comprising
a Each enterprise manager sending the identity of all the locally registered users to all the other enterprise manager using a communication protocol, and keeping this information up to date.

6. The system of claim 1, wherein a voice call or information message targeted at a portable device attached to an enterprise IP network and initiated from the public cellular or telephone network is accomplished by a method comprising,
a Routing the voice signaling or information message to the cellular gateway from within the cellular network, using previously registered location information;
a Detection by the cellular gateway of the identity and address of the enterprise manager under which the portable device is registered;
a Translation of the voice signaling or information message by the cellular gateway into a form recognizable by the enterprise manager, and communication of this to the enterprise manager;
a Detection of the identity and address of the portable device by the enterprise manager upon receipt of the voice signaling or information message from the cellular gateway;
a Delivering the voice signaling or information message to the portable device by the enterprise manager;
a Delivering a response from the portable device to the cellular gateway by the enterprise manager; and
a Signaling a media gateway, if necessary, by the cellular gateway to establish a bearer path to the enterprise manager, and ultimately to the portable device.

7. The system of claim 1, wherein a voice call or messaging communication initiated by a communication device attached to an enterprise IP network is completed by a method comprising,
a Routing the voice signaling or information message to an enterprise manager;
a Detection by the enterprise manager of whether the target of the voice call or information message is presently attached to the enterprise IP network, or it is outside;
a Routing of the voice signaling or information message to another enterprise manager or the target device, if the device is attached to the enterprise network, or routing of the voice signaling or information message to the cellular gateway if the target is outside;
a Completion of the signaling in the reverse direction if the target device is attached to the enterprise IP network, and initiation of bearer traffic directly between the portable devices;
a Routing of the voice signaling or information message to another enterprise manager by the cellular gateway, if the target device is present in another enterprise site;
a Translation of the voice signaling or information message by the cellular gateway, delivery of it to an appropriate cellular network element, completion of the signaling in the reverse direction, and establishment of the bearer path between the source and destination portable devices via a media gateway (in case of voice call), if the target device is outside any enterprise network.

8. The system of claim 1, wherein each enterprise manager further comprises of a programmable software system and hardware interfaces which allows the implementation of various functions such as voice-related supplementary services, unified messaging, data and personal information synchronization, enterprise QoS monitoring and management, and interfacing to other enterprise voice and messaging systems.

9. The system of claim 1, wherein cellular gateway comprises of a programmable software system which allows the expansion of functions related to providing voice, message and data communication capabilities to portable communication devices connected to enterprise IP networks.
